(19) United States
(12) Patent Application Publication
(10) Pub. No.: US 2016/0182582 A1
(43) Pub. Date: Jun. 23, 2016

(54) Sequential Pre-fetch in a Cached Network Environment

(71) Applicants: Arjen Wagenaar, Amsterdam (NL); Dirk Griffioen, Arnhem (NL)

(72) Inventors: Arjen Wagenaar, Amsterdam (NL); Dirk Griffioen, Arnhem (NL)

(73) Assignee: CodeShop BV, Amsterdam (NL)

(21) Appl. No.: 14/580,263

(22) Filed: Dec. 23, 2014

(51) Int. Cl. H04L 29/06; H04L 29/08; H04L 12/861

(52) U.S. Cl. CPC H04L 65/4069; H04L 65/80; H04L 49/90; H04L 67/02

(57) ABSTRACT

An origin-edge node architecture is provided herein where the edge node caches next fragments of media content while fulfilling current media content requests, thereby allowing new requests for the next fragment to be served directly from cache, instead of requiring the edge to request content from the origin again. In such an arrangement, the origin is configured to provide a link header with currently requested media content. The location of the next fragment is presented to the edge node in the Link header, permitting the edge to read that header while processing the request for the requested fragment and ‘behind the scenes’ fetch this next fragment and place it in the edge node local cache. Other embodiments are disclosed.

### FIELD OF THE INVENTION

The embodiments herein relate generally to content delivery and streaming over the Internet, and more particularly to, media content fetching in real-time streaming of media content.

### BACKGROUND

Edge caching refers to distributing content and the use of caching servers to store content closer to end users. For instance, when one visits a popular web site, the downloaded content gets cached, and each subsequent user to that site will get content served directly from the caching server until the content expires.

FIG. 1 illustrates a typical caching setup where a viewer contacts an edge node for a piece of content. If the requested content is cached then the request is served from cache resulting in a ‘cache-hit’. If however, the requested content is not cached, this results in a ‘cache-miss’. In the case of the cache miss, the edge then requests an upstream server (the ‘origin’) for the missing piece of content.

The cache miss means that the first viewer of the content will experience a wait time, resulting in a degradation of the viewer experience to the first viewer, because the content is not in cache. The edge thus has to instead first make an upstream request to the origin; thereby introducing latency.

A need therefore exists in cases of cache miss for improving user experience and delivery of streaming media.

### SUMMARY

An origin-edge node architecture is provided herein to mitigate and substantially remove latency due to cache misses in a content delivery network. One distinguishing feature is that the edge node caches next fragments while fulfilling requests for current fragments. In such architecture, the origin is configured to provide a link header with currently requested media content. Another distinguishing features is that the location of the next fragment is presented to the edge node in this Link header, permitting the edge to read that header while processing the request for the requested fragment, and fetch this fragment in a (“behind the scenes”) process that places it in the edge node local cache. The “behind-the-scenes” fetched fragment carries the Link header, which is then cached; a process which is sequentially repeated as real-time media content requests are fulfilled. In the case where the viewer will always only request from the edge node, the latency associated with the next request to the origin is removed because the edge node will thus already have the next fragment cached.

In a first embodiment, a method for sequential pre-fetch of media content suitable for use in a cached network environment is provided. The method includes program steps, implemented by computer instructions operating within a computing machine, performed at an origin and an edge node. By way of the method, the origin exposes a location of a next chunk of media in a link header in addition to the current chunk of media requested. The edge node upon pulling the origin for media content, receives this link header identifying the next chunk with the current chunk, and pre-fetches the next chunk of media from the location ahead of a media play time. It caches this next chunk of media locally from the location to a local cache for providing to a viewer at a later play time, and provides the next chunk of media at the later play time to the viewer to fulfill an expected subsequent viewer request for the media content. The pre-fetching is a sequential pre-fetching operation for the next chunk of media identified in the link header. The sequential pre-fetching operation allows for streaming of live media or video on demand without incurring a wait time for first time viewers. In such capacity, the method combines the simplicity of an origin created header (e.g., in web link format such as RFC 5988) with edge specific logic to prime the edge cache, in effect reducing latency and thereby improving quality of the viewing experience.

In particular, the next chunk of media is identified by a parameter in the link header responsive to a pull request for a current demand of media content. The edge node upon receiving the link header from the origin reads the relative parameter identifying a location and format of the next chunk. The edge node while fulfilling the current demand from the viewer for the media content also pre-fetches the next chunk of media content in view of the relative parameter in the link header. The edge node then locally caches at least one fragment of the next chunk of media in a local cache at the edge node, before it is requested, for providing to the viewer at the later play time. In a following request from the viewer, the edge node then responds with the next chunk resulting in a cache-hit by way of the caching of the one or more fragments responsive to a secondary request for the media content. In such manner, the edge node reduces a latency of the media content delivery comprising the one or more fragments by pulling from the local cache.

In a second embodiment, a system for sequential pre-fetch of media content suitable for use in a cached network environment is provided. The system includes an origin and an edge node communicatively coupled together. The edge node is also communicatively coupled to a viewer that presents media content. Responsive to a request from the viewer for media content, the edge node pulls the origin for the media content. The origin returns a current chunk of media (or fragment of the requested media content) and a link header that identifies a link to a next chunk of media content. The edge node retrieves the current chunk of media indentified (or delegates such task), and also determines from the link header a location and format for the next chunk of media.

The edge node, responsive to determining the location of the next chunk of media in the link header, pre-fetches the next chunk of media from the origin (or other server) for a later media play whilst providing the current chunk of media content to the viewer. In one arrangement the origin only adds the location of the next chunk in the link header responsive to the pull for the current media from the edge node per request. In another arrangement, the origin always includes a parameter for identification of the next chunk for a particular edge node without explicit request from that edge node. The origin will add at least one link in the exposed header to the next chunk of media comprising the media content.

In another arrangement, the link header includes additional data parameter links associated with the next chunk, including but not limited to, all supported bit rates and formats for the next chunk. A data parameter link may itself be a link to retrieve such information associated with the next chunk, or comprise parameters directly listing parameter and value pairs or combinations thereof. The edge node upon receiving the next chunk with additional parameter links can then elect to shift up or shift down the bit rate for the next chunk based on the supported data formats identified from the parameters and store them in various bitrates and formats to cache for retrieval in accordance with content management or content delivery requirements or demands.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a system of edge caching for media delivery;

FIG. 2A is an exemplary system enhanced with an origin returning a link header with media content in accordance with one embodiment;

FIG. 2B illustrates an exemplary link header in accordance with one embodiment;

FIG. 3 depicts components of the system of FIG. 2A for pre-fetching of media content in accordance with one embodiment;

FIG. 4 depicts components of the system of FIG. 2A for serving pre-fetched media content in accordance with one embodiment;

FIG. 5A is a diagrammatic representation of a machine in the form of a computer system within which a set of instructions, when executed, may cause the machine to perform any one or more of the methodologies herein; and

FIG. 5B depicts a system incorporating the machine of FIG. 5A for managing and serving of pre-fetched media content in accordance with one embodiment.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

Briefly, the terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “streaming”, “streaming media”, and “streaming media protocol” are intended to broadly encompass any media program or protocol including at least digital video and/or digital audio content which can be rendered and played by a rendering device at the receiving end of one or more wired or wireless data connections. Streaming media or streaming media programs can be audio programs and/or music, video on demand programs, linear video programs, live video programs or interactive programs and can be transported through the data network in any suitable manner as will occur to those of skill in the art.

The term “viewer” is intended to mean in one case a person that receives or provides user feedback and in another case a device or electronic communication display that visually presents information which the person views. The term “player” is intended to mean a software program or device that visually presents or exposes media with or without media functionality or interaction to a viewer/person. The term “ad” is short notation for advertisement which can mean any form of paid or non-paid solicitation, marketing, information, material or notice promoting a product, service, event, activity or information.

The terms “origin” and “content server” are intended to mean similarly a repository for multimedia, business forms, documents, and related data, along with metadata, that allows users to process and work with the above content or media. The term “local” is intended to mean information associated with a user (person), user device or service, for example, geographic location of the user, or geographic location of an advertised service or event, or other information including but not limited to business identifier, network identifier, mobile device identifier, or logon profile.

The term “processing” can be defined as number of suitable processors, controllers, units, or the like that carry out a pre-programmed or programmed set of instructions. The terms “program” and “method” are intended to broadly mean a sequence of instructions or events for the performance of a task, which may be executed on a machine, processor or device.

Also as used herein, the term URI is meant to broadly include any suitable method of identifying data available for access through a network, such as the URIs defined in the IETF RFC3986 “Uniform Resource Identifier (URI): Generic Syntax”, or any other suitable mechanism, system or method for identifying such data. The term header is meant to broadly include any suitable method or object identifying a type or format of media content, such as origin headers in IETF RFC 5988. Furthermore, as used herein the term “inserted content” and/or “dynamically inserted content” is intended to comprise any media content, video and/or audio, which it is desired to insert into a streaming media program. While the most common example of inserted content may be advertising programming, it is also contemplated that other content can be inserted, if desired, and such inserted content can include: alternate endings to streaming media programs; substitution of program durations with other programs or black screens such as for sports “blackouts”; changes to scenes or portions of scenes within a streaming media program; TV-like “channel surfing” through available streaming media programs, live or on demand, where the inserted content is the streaming media program on the channel the user switches to; etc. Further, inserted content can be overlay content displayed or played in combination with the main program.

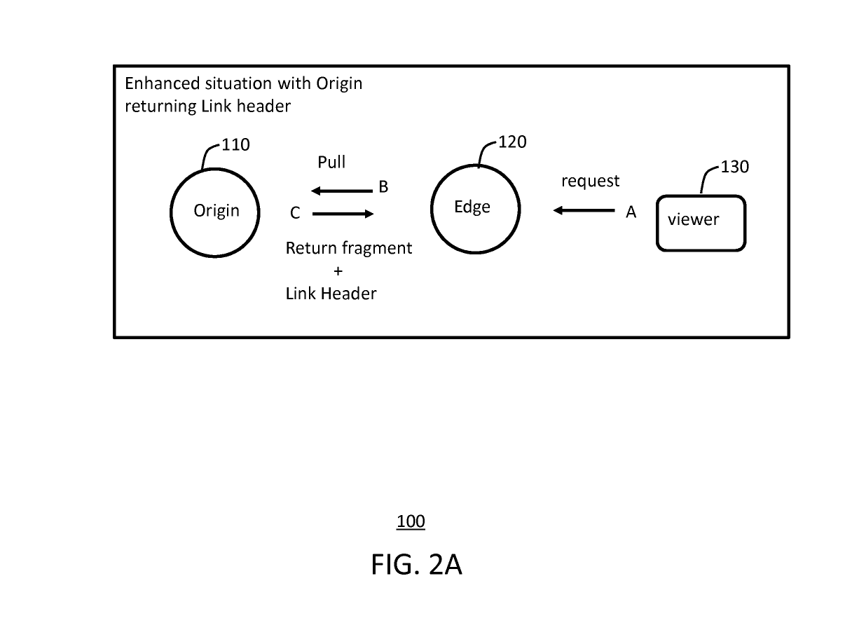

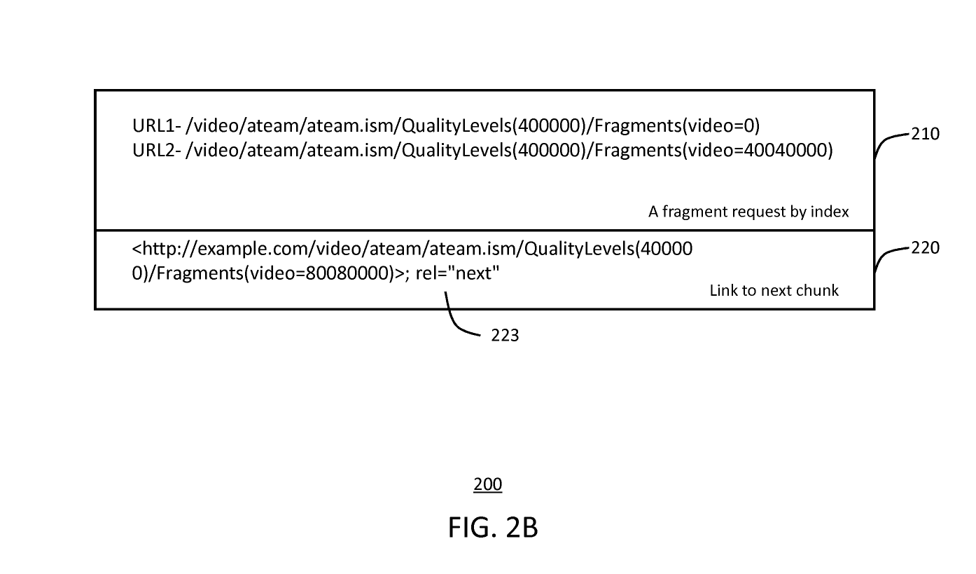

FIG. 2A depicts a system 100 for sequential pre-fetch in a cached network environment in accordance with one embodiment. The system 100 includes an origin 110 and an edge node 120, and indirectly a viewer 130, which are all communicatively coupled together, for example, over Ethernet or Wi-Fi via one or more protocols, for example, hyper text transfer protocol (HTTP). A series of method steps (A, B and C) are also shown depicting unique message exchange and media content communicated between the shown components of the system. Reference will be made to components of the system 100 when describing these method steps.

The origin 110 provides media content responsive to a request from the viewer 130 by way of the edge node 120, for example, streaming media or live video within a Content Delivery Network (CDN). The edge node 120 is a proxy cache that work in a manner similar to a browser cache. When a request comes into an edge node, it first checks the cache to see if the content is present. The cache key is the entire URL including query check cache keys (e.g., like in a browser). If the content is in cache and the cache entry has not expired, then the content is served directly from the edge server. If however the content is not in the cache or the cache entry has expired, then the edge node 120 makes a request to the origin 110 to retrieve the information. The origin 110 is the source of content and is capable of serving all of the content that is available on the CDN. When the edge server receives the response from the origin server, it stores the content in cache based on the HTTP headers of the response.

One enhancement of the system 100 over the prior art is that the origin 110 returns a link header with the current chunk of media content. The link header is a novel component that is described in more detail ahead. Briefly, the media content may be delivered in one or more chunks, also referred herein to as fragments. As one example, the edge note 120 at step A in response to a user demanding to receive streaming live video via the viewer 130, makes requests to the origin 110 to fulfill a delivery of media content, for example, live video. To fulfill the request, the edge node 120 determines where to find a source of the media, in this case, the origin 110, from which to pull the media content as shown in step B. The origin 110 returns a fragment (is also a current chunk of the media content) and the link header; the latter identifying chunks of media that the edge node 120 may fetch, and as will be discussed ahead, pre-fetching of next chunks of media content. The viewer 130 thereafter assembles the chunks of media as they are received, in one arrangement, in accordance with one or more parameters (e.g., data rate, time base) to provide for continuous media delivery and viewing to achieve a predetermined quality of service.

Referring to FIG. 2B, the link header 200 is shown in accordance with one embodiment. The link header 200 includes one or more links 210 where the edge node 120 can retrieve the current chunk of media content, and includes at least one link 220 for the next chunk of media in accordance with the inventive aspects herein described. The chunk and link use the same fragment. Typically, the viewer 110 requests fragments by some kind of index (in HLS the .m3u8 file, in Smooth Streaming the Manifest), where the time base for HTTP Live Streaming (HLS) will be 1.ts, 2.ts etc. Typically, a player requests fragments by some kind of index—in HTTP Live Streaming (HLS) for instance this looks like

/video/ateam/ateam.ism/ateam-audio=128000video=400000.m3u8
/video/ateam/ateam.ism/ateam-audio=128000-video=400000-1.ts
/video/ateam/ateam.ism/ateam-audio=128000-video=400000-2.ts
and for instance for Smooth Streaming:
/video/ateam/ateam.ism/Manifest
/video/ateam/ateam.ism/QualityLevels(400000)/Fragments(video=0)
/video/ateam/ateam.ism/QualityLevels(400000)/Fragments(video=40040000)

In a Live stream or VOD stream it may be assumed viewers will want the next chunk, as they are watching the event or movie to the end. No complex setup or advanced assumptions are needed as for instance viewing history. The origin 110 provides the requested fragments for the current chunk 210 and also the links for the next chunk of media 220. As it is likely that as long as the video (Live or VOD) has not ended, the viewer 110 will want to continue (and see the whole event or movie), and accordingly, the edge note 120 will also request the next fragment. Since the origin already knows the format and location of the next fragment, and also for a given bit rate, it adds the URL for the next chunk to the HTTP header. In one configuration, it does this by way of the Link header identified in RFC5988, for example, which is provided via as the rel parameter 223 in the link header 200, though other parameters are also herein contemplated. The rel parameter 223 gives a relative location in the link header 200 for the next chunk of media at the edge node.

One distinguishing feature of the system 100 architecture is that the edge node 120 performs a sequential pre-fetch of media content in the context of a cached network environment. That is, it pre-fetches the next media chunk for placement in local cache sequential to caching the current media chunk. The edge node 120 includes a local cache to which it can temporarily store chunks of media; namely, currently request chunks, and also next chunks. It is able to do this because the origin 110, through the methods herein described, returns the link header 200 together with the requested chunk of media for streaming fragments of the media content. In a typical scenario, the origin 110 only returns a current media chunk. The origin 110, in accordance with the inventive methods herein, additionally includes a link with relative parameter 223 for the next chunk of media, instead of the origin 110 only fulfilling the typical request for the current chunk of media. In this way, the edge note 120 delivers to the viewer 110 the current chunk of media; that is, it not only caches the current chunk of media received from the origin 110, but during this step, also pre-fetches the next chunk of media content and stores it locally in its cache.

Sequential pre-fetch solves the first viewer problem in a cached network environment, for instance a Content Delivery Network (CDN) or comparable setups involving transparent caching with edges and origins. The edge node 120 does this by pre-fetching the next chunks of media and caching it locally such that the chunk will already be in the edge cache (because it is pre-fetched). This results in the viewer 130 experiencing no wait time due to the latency introduced by a cache miss. Sequential pre-fetch improves viewer experience, the quality of service, and optimizes network efficiency as cache hit ratio's are improved and cache misses reduced. This creates value in both the end-user's experience as well as the CDN's hardware and bandwidth utilization.

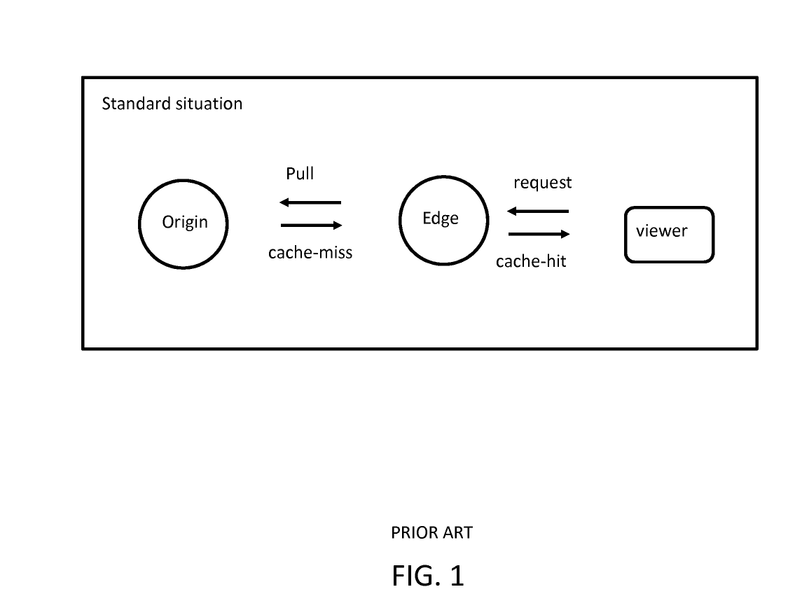

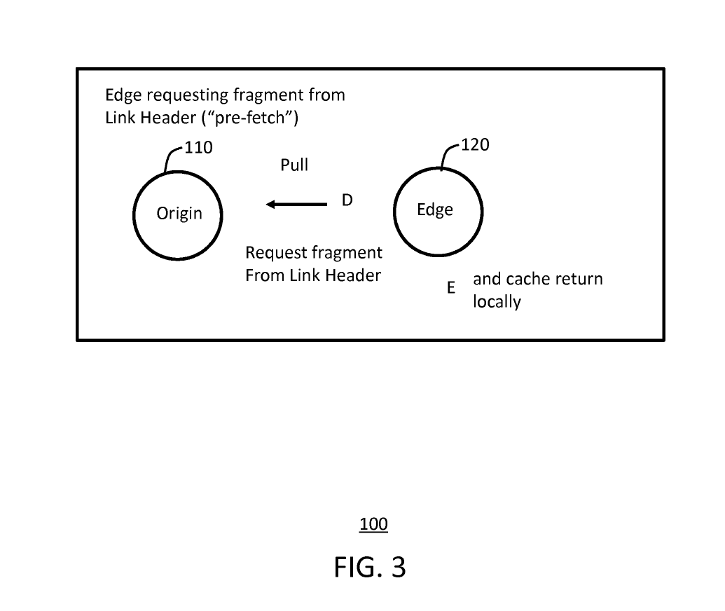

FIG. 3 is a pre-fetch illustration of the system shown in FIG. 2 for the aspects of pre-fetching of media content in accordance with one embodiment. A series of method steps D-E are also shown which follow in sequence from method steps A-C shown in previous FIG. 1. In this example, the edge node 120, at step D, requests the fragment previously identified in the link header 200. Notably, step D for pre-fetching the next chunk of media occurs whilst the edge node 120 is delivering the current media chunk to the viewer 130 (see FIG. 1). That is, the method step D occurs, not for a current request of media content, but rather, in anticipation of a request from the viewer 120 for the next chunk of media. This also may be based on viewer habits, heuristics and preferences, for example, if logic determines that the user is interested in the viewed material, or related media, or has expressed interest in continued viewing.

The method of pre-fetch is implemented in one of two ways which are selectively configurable. The edge node can selectively determine which one of the ways to pre-fetch depending on a user request, user demand context or responsive to content delivery rules. By the first way, the edge node 120 fetches all fragments by going through each link header 200 so the edge cache 120 is filled with the whole media (e.g., movie, song) triggered by one request, which may be a recursive process. Also, as previously noted, the origin 110 can supply additional data parameters within the link header identifying options for the pre-fetch retrieval. For example, the edge node 120 may determine from the link header 200 that multiple bitrates are available for the pre-fetch. The edge node can retrieve the media for any one of the supported bit rates, sequentially or in parallel, as part of the pre-fetch. Moreover, the edge node 120 may configure certain network parameters along the path to the origin 110 in accordance with the identified data parameters, for example, switching to another communication protocol to retrieve a media in a certain format, or delegating retrieval to other process threads according to a data rate quality metric.

By the second way, the edge node 120 responsive to a cache miss triggers a request to the origin to fulfill a media request for a current chunk, wherein the reply from the origin includes the currently requested chunk (fulfilling the cache miss) with the link header for the next chunk. The edge node 120 then pre-fetches the next chunk (identified in the link header for the current chunk request) and stores that next chunk along with its link header (also identifying yet another next chunk) in the cache. The edge node may continue to read the link headers for the yet another next chunk and so on in a continual pre-fetch loop until the cache is full or a predetermined buffer size is achieved. In this manner, the cache-miss triggers an origin 110 reply with the link header 200, where the link header 200 fragment then is fetched and cached, when that fragment is requested the edge node 120 may look at the also cached header of the link header 200 cached fragment to fetch the next one when it serves the first link header cached fragment (so the next is only fetched when one fragment is served).

The method of pre-fetching described above may further include steps that anticipate timing of ad placement within streamed media and manage pre-fetching accordingly. Upon the origin 110 returning the next chunk of media responsive to the pre-fetch, the edge node 120 then caches this next chunk for an anticipated cache access at a later time. Notably, the origin incorporates the method steps required to expose the location of the next chunk in the HTTP header it sends with the fulfillment of an edge request. Similarly, the edge incorporates the method required to read the header and fetch the next chunk listed to put it in its local cache. In one configuration, the edge node 120 uses an embedded programming language (‘Lua’) to read the origin created HTTP header and manipulate its local cache.

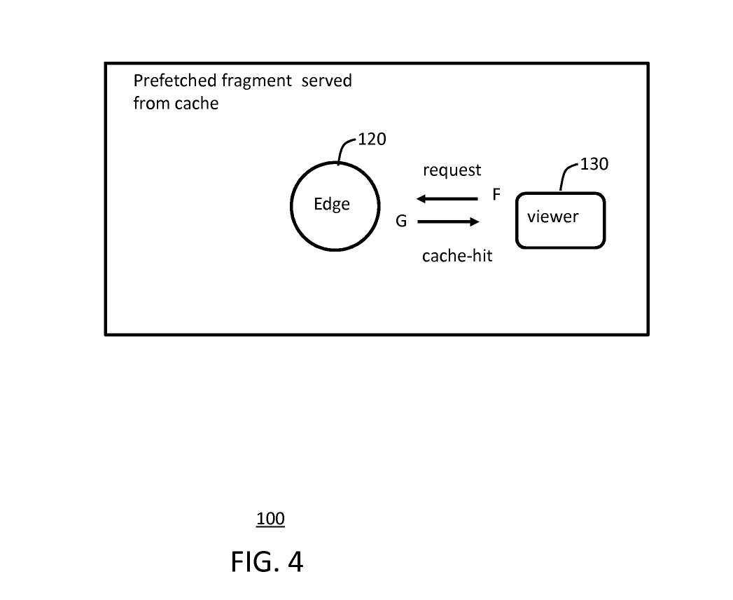

FIG. 4 is a cache illustration of the system shown in FIG. 2 for aspects of serving pre-fetched media content in accordance with one embodiment. A series of method steps F-G are also shown which follow in sequence from method steps A-E shown in previous FIG. 2A and FIG. 3. Continuing with the example, the edge node 120 upon receiving a following request for media content at step F, and having already pre-fetched the fragment for the next chunk of media, now provides this next chunk from local cache as shown in step G. This results in a cache hit rather than a cache miss because the media content requested is now available in local cache, even though it was not previously provided to the viewer 130. Recall, local cache on the edge node 120 is generally reserved for consumed content. In this case, the content has not yet been consumed, but rather was anticipated and fulfilled by way of the sequential pre-fetch method herein described.

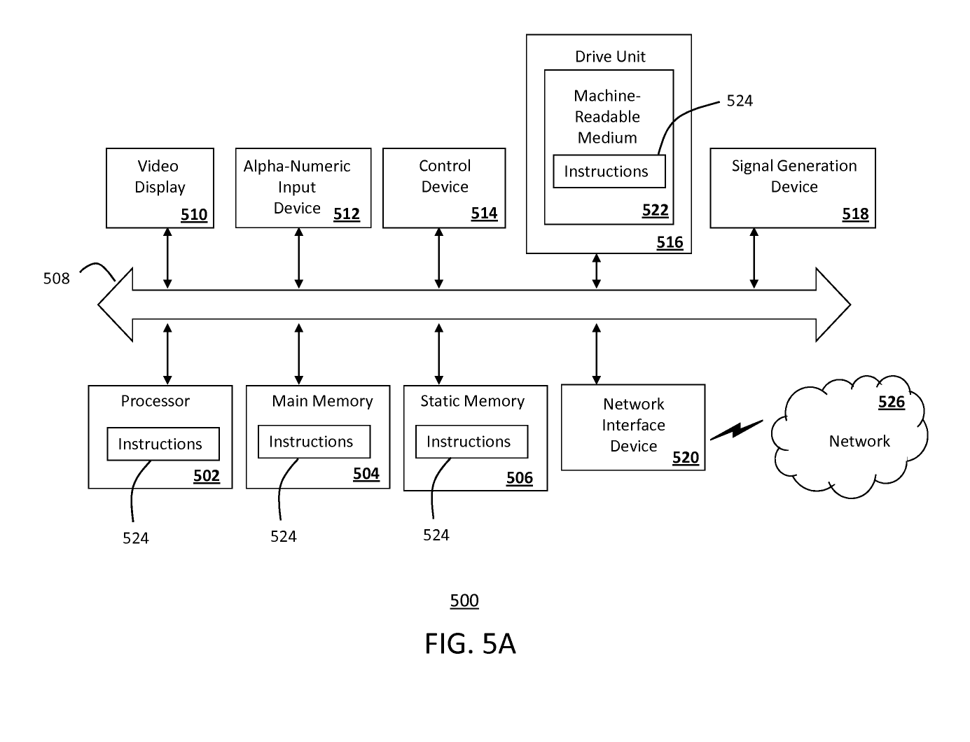

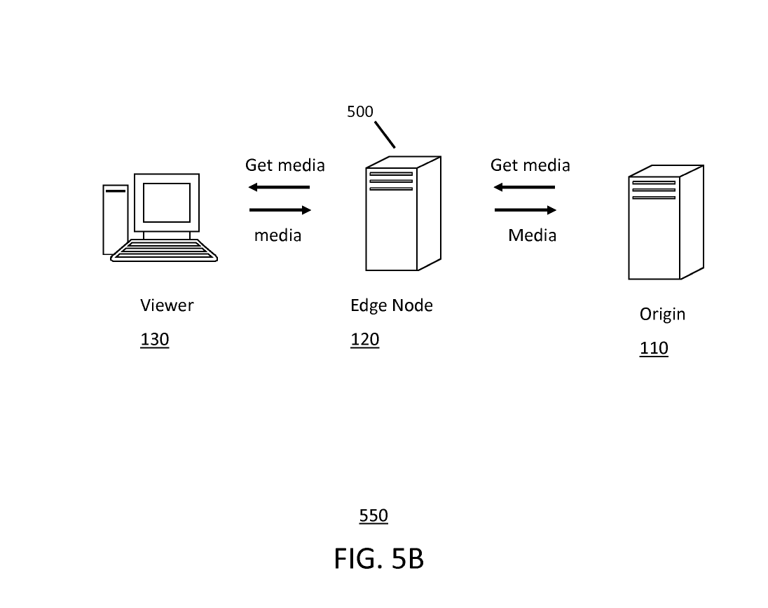

FIG. 5 depicts an exemplary diagrammatic representation of a machine in the form of a computer system 500 within which a set of instructions, when executed, may cause the machine to perform any one or more of the methodologies (or protocols) discussed above. In some embodiments, the machine operates as a standalone device. In some embodiments, the machine may be connected (e.g., using a network 526) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, OLED). The computer system 500 may include an input device 512 (e.g., a keyboard), a control device 514 (e.g., a mouse), a mass storage medium 516, a signal generation device 518 (e.g., a speaker or remote control) and a network interface device 520.

The mass storage medium 516 may include a computer-readable storage medium 522 on which is stored one or more sets of instructions (e.g., software 524) embodying any one or more of the methodologies or functions described herein, including those methods illustrated above. The computer-readable storage medium 522 can be an electromechanical medium such as a common disk drive, or a mass storage medium with no moving parts such as Flash or like non-volatile memories. The instructions 524 may also reside, completely or at least partially, within the main memory 504, the static memory 506, and/or within the processor 502 during execution thereof by the computer system 500. The main memory 504 and the processor 502 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

For example, referring to FIG. 5B, the machine 500 can be included in part or whole, with any of the system components shown (Viewer, Edge Node or Origin). For instance, the Edge Node 120 can include the machine 500, or any part thereof, for performing one or more computer instructions for implementing the method steps directed to programming of the edge node as discussed herein. Similarly, the Origin 11 can also include the machine 500, or any part thereof, for performing one or more computer instructions for implementing the method steps directed to programming of the origin as discussed herein.

Where applicable, the present embodiments of the invention can be realized in hardware, software or a combination of hardware and software. Any kind of computer system or other apparatus adapted for carrying out the methods described herein are suitable. A typical combination of hardware and software can be a portable communications device with a computer program that, when being loaded and executed, can control the portable communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments are not so limited. Numerous modifications, changes, variations, substitutions and equivalents will occur to those skilled in the art without departing from the spirit and scope of the present embodiments of the invention as defined by the appended claims.

What is claimed is:

1. A method for sequential pre-fetch of media content suitable for use in a cached network environment, the method comprising the steps of:
at an origin, exposing a location of a next chunk of media in a link header for a media content;
at an edge node communicatively coupled to the origin,
pre-fetching the next chunk of media from the location ahead of a media play time;
caching the next chunk of media locally from the location to a local cache for providing to a viewer at a later play time; and
providing the next chunk of media at the later play time to the viewer to fulfill an expected subsequent viewer request for the media content.

2. The method of claim 1, where the pre-fetching is a sequential pre-fetching operation for the next chunk of media identified in the link header.

3. The method of claim 2, further comprising streaming live media or video on demand by way of the sequential pre-fetching operation.

4. The method of claim 1, comprising returning next chunk of media identified in the link header responsive to a pull request for the media content.

5. The method of claim 4, further comprising reading a relative location in the link header for the next chunk of media at the edge node.

6. The method of claim 5, further comprising caching one or more fragments of the next chunk of media in a local cache at the edge node for providing to the viewer at the later play time.

7. The method of claim 6, further comprising responding with a cache-hit by way of the caching of the one or more fragments responsive to a following request for the media content.

8. The method of claim 6, further comprising reducing a latency of the one or more fragments by delivering from the local cache.

9. A system for sequential pre-fetch of media content suitable for use in a cached network environment, the system comprising:
an origin that returns a current chunk of media and a link header identifying a next chunk of media;
an edge node that responsive to a request from a viewer for receiving media content:
pulls the origin for the current chunk of media;
determines from the link header the next chunk of media;
pre-fetches the next chunk of media;
caches the next chunk of media locally to a local cache; and

10. The system of claim 9, where the edge node provides the next chunk of media from a local cache to the viewer at a later play time responsive to a request from the viewer for the media content.

11. The system of claim 9, where the origin adds a location of the next chunk in the link header responsive to the pull for the current media.

12. The system of claim 9, where the origin adds at least one link in the exposed header to the next chunk of media comprising the media content.

13. The system of claim 9, where the edge node caches the next chunk of media locally from the location to a local cache for the later play time whilst delivering to the viewer the current chunk of media.

14. The system of claim 11, where the edge node responsive to determining the location of the next chunk of media, pre-fetches the next chunk of media for the later media play whilst providing the current chunk of media content.

15. The system of claim 12, where the at least one link is hyper text transfer protocol (http) format.

16. The system of claim 9, where the link header includes an additional data parameter associated with the next chunk, identifying all supported bit rates, formats and encodings available for the next chunk,
where the edge node retrieves the next chunk according to at least one of an index, a data rate, a format and a quality metric identified in the additional data parameter.

17. The system of claim 16, where the index identifies a time sequence for the next chunk.

18. The system of claim 9,
where the origin adds a URL for the next chunk of media content to an HTTP header of the link header,
such that each return on a request from the viewer includes in the HTTP header the location of the next chunk of media content.

19. The system of claim 9, where link header includes a relative parameter indicating a relative URI target location to receive the next chunk of media content.

20. The system of claim 9, where link header includes a relative parameter indicating a relation name associated with the next chunk of media content.
